(19) United States
(12) Patent Application Publication
(10) Pub. No.: US 2020/0375694 A1
(43) Pub. Date: Dec. 3, 2020

(54) ARTIFICIAL TOOTH WITH MULTIPLE INTERNAL CROWNS AND SPRING CLIP

(71) Applicants: TAI WU LIN, TAIPEI CITY (TW); YEN TING LIN, TAIPEI CITY (TW)

(72) Inventors: TAI WU LIN, TAIPEI CITY (TW); YEN TING LIN, TAIPEI CITY (TW)

(21) Appl. No.: 16/426,294

(22) Filed: May 30, 2019

(51) Int. Cl. A61C 5/30; A61C 13/267

(52) U.S. Cl. CPC A61C 5/30; A61C 2201/007; A61C 13/267

(57) ABSTRACT

The present invention provides an artificial tooth comprising a plurality of internal crown members, a plurality of connecting rods, at least one external crown member, at least one spring clip. The internal crown members are respectively fitted to a plurality of abutments. Each of the connecting rods connects to at least two of the internal crown members. The external crown member has at least one groove therein, and the groove is formed to correspond to the internal crown members. The spring clip clamps a protrusion block formed on the internal crown members or on an adjacent tooth. Further, the spring clip comprises two spring arms opposite each other, and each of two spring arms has a fixed end and a movable end opposite to fixed end. Each of two spring arms connects to the fixed end and the movable end, and fixed end is fixed inside the internal crown members.

### TECHNICAL FIELD OF THE INVENTION

The present invention relates to an artificial tooth, and more particularly to an artificial tooth having multiple tooth-root internal crowns and assembled with at least one spring clip.

### DESCRIPTION OF THE PRIOR ART

An artificial tooth is used to rebuild a damage tooth of a patient in order to maintain normal function of mastication of the patient and to keep the tooth again subsequent corrosion.

A known structure of artificial tooth that is currently available is composed of internal and external crown members. The internal crown is mounted to a natural tooth and the external crown is attached to the internal crown. Thereby, the external crown can be removed and cleaned, and the food debris accumulated between the internal crown and the gum can be cleaned to avoid the problem of periodontitis. The removable artificial tooth is fixed by the frictional force between the surfaces of internal and external crown, and the external crown can be directly removed for cleaning. When the external crown is worn or accidentally damaged, the external crown can be directly repaired. However, the disadvantage is that the mounting stability of the external crown is not good, and the external crown and the internal crown are fixed by the frictional force therebetween. When the frictional force is small, the external crown is easy to fall off when chewing food, especially the sticky food. On the other hand, when the frictional force between the internal and external crowns is too large, the external crown will be stuck and cannot be removed.

### SUMMARY OF THE INVENTION

The present disclosure overcomes the presently technical drawback. The main purpose of the present invention is to provide an artificial tooth having multiple tooth-root internal crowns and a spring clip to improve the mounting stability between the external crown and internal crown. Further, the artificial tooth of the present invention can avoid problems that the external crown is easy to fall off, the external crown will be stuck and cannot be removed.

To achieve the above object, the present invention provides an artificial tooth comprising a plurality of internal crown members, a plurality of connecting rods, at least one external crown member, and at least one spring clip. First, the internal crown members are respectively fitted to a plurality of abutments. Secondly, each of the connecting rods connects to at least two of the internal crown members. Further, the external crown member has at least one groove therein, and the groove is formed to correspond to the internal crown members. Furthermore, the spring clip clamps a protrusion block formed on the internal crown members or on an adjacent tooth; wherein the spring clip comprises two spring arms faced each other; the two spring arms have a first fixed end, a second fixed end, a first movable end and a second movable end; and the first fixed end opposites to the first movable end; the second fixed end opposites to the second movable end. Additionally, the first fixed end connects to the second fixed end; the first movable end faces to the second movable end; and the first fixed end and the second fixed end are fixed inside the external crown members.

In the artificial tooth of the present invention, the artificial tooth further comprises an adhesive used for adhering first fixed end and the second fixed end to fix the spring clip on the external crown member.

In the artificial tooth of the present invention, the artificial tooth further comprises a first neck portion disposed between the first fixed end and the first movable end, and a second neck portion disposed between the second fixed end and the second movable end; a first distance between the first neck portion and the second neck portion is less than a diameter of the protrusion block, so that the protrusion block is located between the two spring arms.

In the artificial tooth of the present invention, the artificial tooth further comprises fixing components mounted on the facing surfaces of the two spring arms to clamp the protrusion block, and the fixing components are consecutive projections corresponding to each other.

In the artificial tooth of the present invention, the fixing components are a plurality of zigzag units, a plurality of circular arc units or a plurality of elliptical units, such that the protruding block is fastened by the fixing components.

In the artificial tooth of the present invention, a second distance formed between the fixing components mounted on the facing surfaces of the two spring arms is less than a diameter of the protrusion block, when the external crown member is pressed down to fasten internal crown members, the fixing components are expanded by the protrusion block, so that the protrusion block is located between the two spring arms.

In the artificial tooth of the present invention, the spring clip clamps at least one connecting rod to fasten external crown member to internal crown members.

In the artificial tooth of the present invention, the two spring arms are NiTi memory metal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing the assembling of internal and external crown according to first embodiment of the present invention.

FIG. 2 is a schematic view showing the assembling of internal and external crown according to second embodiment of the present invention.

FIG. 3 is a schematic view showing the assembling of internal and external crown according to third embodiment of the present invention.

FIG. 4 is a cross-sectional view of the assembling of internal and external crown according to third embodiment of the present invention.

FIG. 5 is a schematic view showing the assembling of internal and external crown according to fourth embodiment of the present invention.

FIG. 6 is a schematic view showing configuration of the spring clip according to first embodiment present invention.

FIG. 7 is a schematic view showing configuration of the spring clip according to second embodiment present invention.

FIG. 8 is a schematic view showing configuration of the spring clip according to third embodiment present invention.

FIG. 9 is a schematic view showing configuration of the spring clip according to fourth embodiment present invention.

FIG. 10 is a schematic view showing spring clip clamping protrusion block according to fifth embodiment present invention.

FIG. 11 is a schematic view showing spring clip clamping protrusion block according to sixth embodiment present invention.

### DETAILED DESCRIPTION OF THE PREFERRED EMBODIMENTS

In the following paragraphs, a detailed description is provided for a thorough understanding of the figures listed above. Well-known structures and devices will also be used schematically for better comprehension.

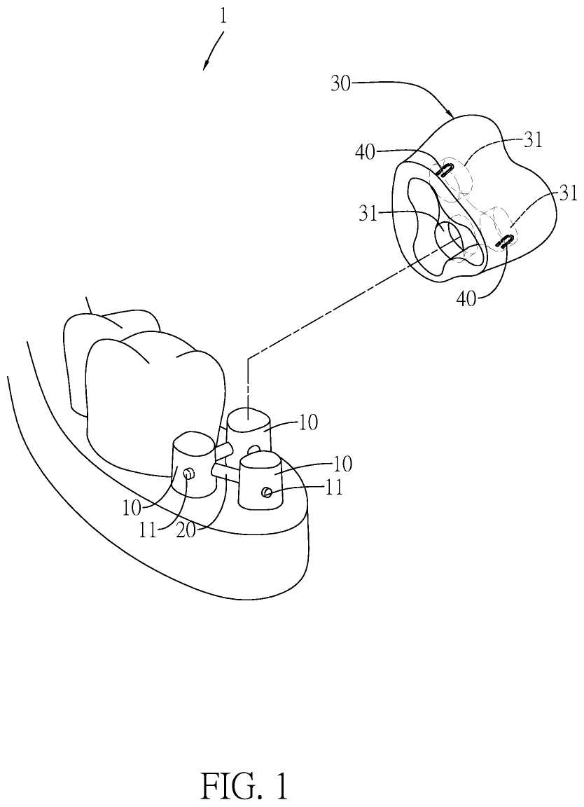

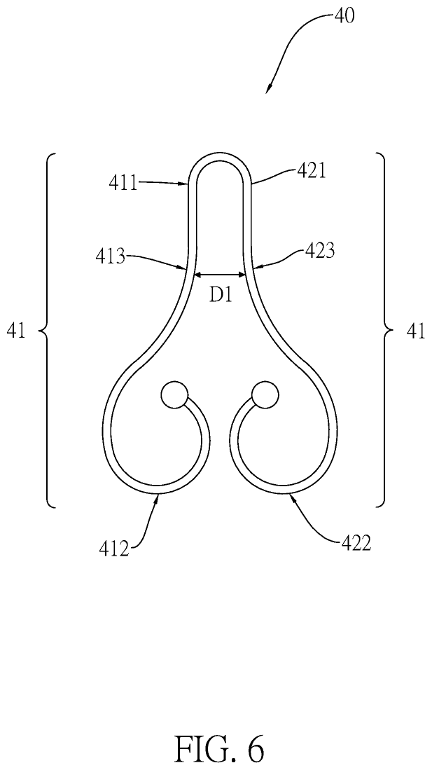

Please refer to FIG. 1, FIG. 1 is a schematic view showing the assembling of internal and external crown according to first embodiment of the present invention. As seen in FIG. 1, an artificial tooth 1 comprises a plurality of internal crown members 10, a plurality of connecting rods 20, at least one external crown member 30 and at least one spring clip 40. The internal crown members 10 are respectively fitted to a plurality of abutments (not shown in figure); and each of connecting rods 20 connects to at least two of the internal crown members 10. Further, the external crown member 30 has at least one groove 31 therein, the groove 31 being formed to correspond to the internal crown members 10. Furthermore, the spring clip 40 clamps a protrusion block 11 formed on the internal crown members 10. Please refer to FIG. 6, FIG. 6 is a schematic view showing configuration of the spring clip according to first embodiment present invention. As seen in FIG. 6, the spring clip 40 comprises two spring arms 41 faced each other; the two spring arms 41 have first fixed end 411, second fixed end 421, first movable end 412 and second movable end 422; and the first fixed end 411 opposites to the first movable end 412; the second fixed end 421 opposites to the second movable end 422; wherein the two spring arms 41 are NiTi memory metal. Additionally, the first fixed end 411 connects to the second fixed end 421; the first movable end 412 faces to the second movable end 422; and the first fixed end 411 and the second fixed end 421 are fixed inside the internal crown members 10.

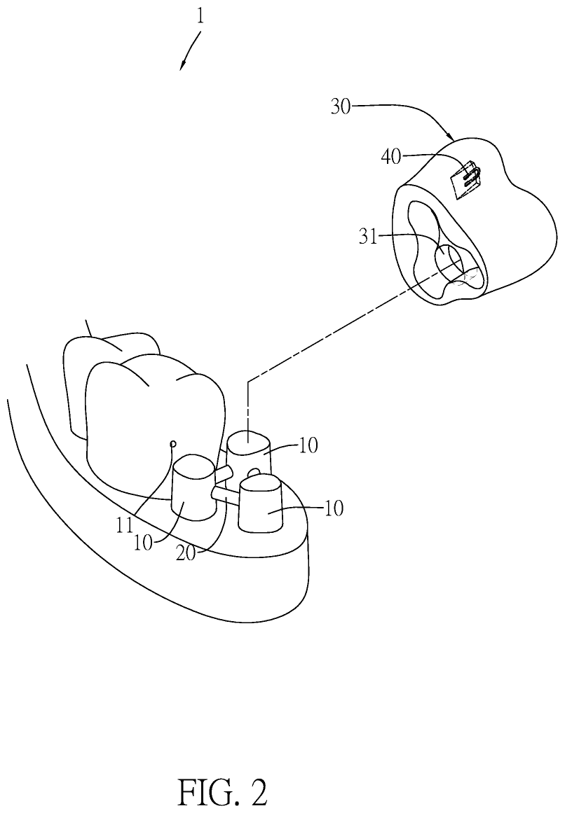

Please refer to FIG. 2, FIG. 2 is a schematic view showing the assembling of internal and external crown according to second embodiment of the present invention. As seen in FIG. 2, the artificial tooth 1 of second embodiment of the present invention is substantially the same as the above first embodiment, but the differences are as following. In the artificial tooth 1 of first embodiment, as shown in FIG. 1, the spring clip 40 clamps a protrusion block 11 formed on the internal crown members 10, but in the second embodiment, as shown in FIG. 2, the spring clip 40 clamps the protrusion block 11 formed on an adjacent tooth.

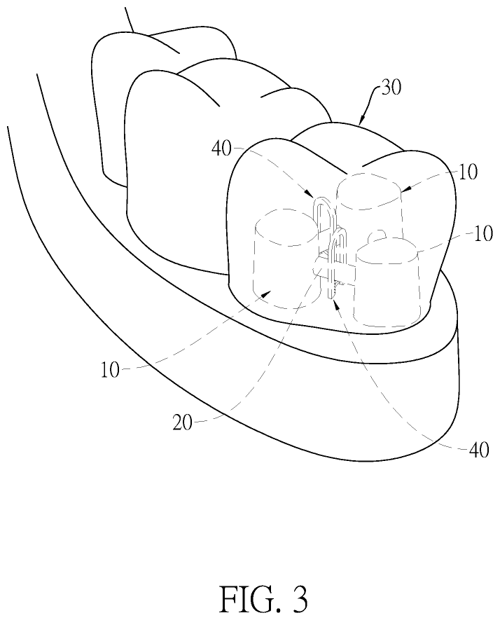

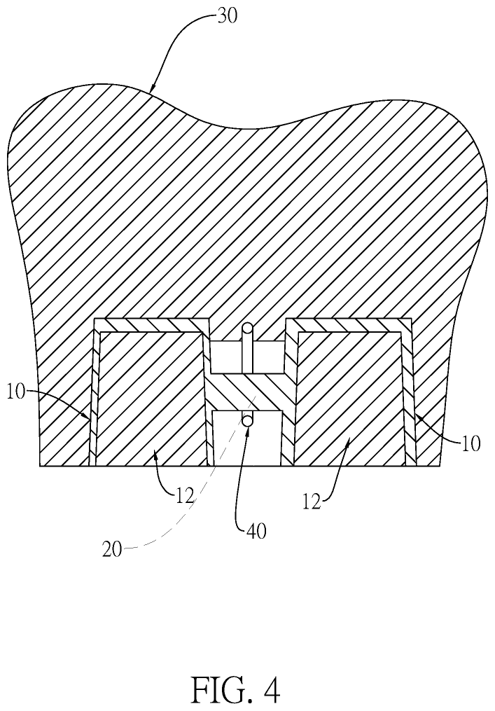

Please refer to FIG. 3 and FIG. 4, FIG. 3 is a schematic view showing the assembling of internal and external crown according to third embodiment of the present invention; and FIG. 4 is a cross-sectional view of the assembling of internal and external crown according to third embodiment of the present invention. As seen in FIG. 3 and FIG. 4, the artificial tooth 1 of third embodiment of the present invention is substantially the same as the above first embodiment, but the differences are as following. In the artificial tooth 1 of first embodiment, as shown in FIG. 1, the spring clip 40 clamps a protrusion block 11 formed on the internal crown members 10, but in the third embodiment, as shown in FIG. 3, the spring clip 40 clamps at least one connecting rod 20. As seen in FIG. 4, the internal crown members 10 are respectively fitted to a plurality of abutments 12; and each of connecting rods 20 connects to at least two of the internal crown members 10. Further, as seen in FIG. 3 and FIG. 4, the spring clip 40 clamps at least one connecting rod 20 to fasten external crown member 30 to internal crown members 10.

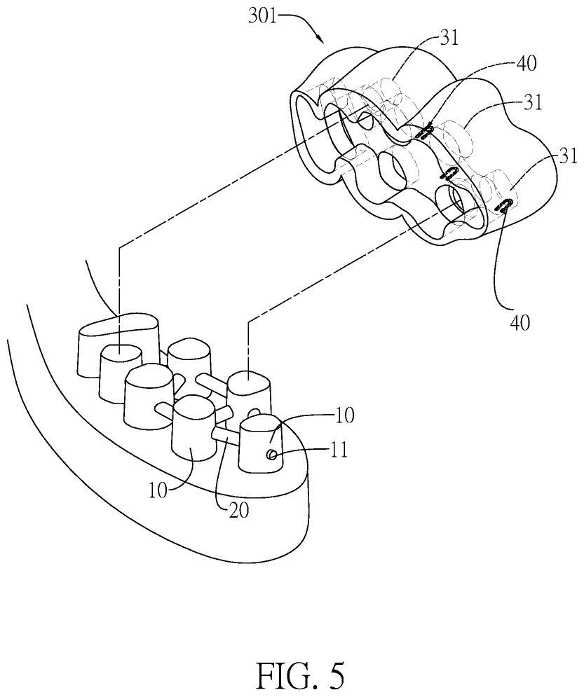

Please refer to FIG. 5, FIG. 5 is a schematic view showing the assembling of internal and external crown according to fourth embodiment of the present invention. As seen in FIG. 5, a different structure of the external crown member 30 is provided, which comprises a plurality of artificial tooth combination bodies 301 and is not limited to application to a single natural tooth; wherein the spring clips 40 clamp the protrusion block 11 formed on the internal crown members 10, and the spring clip 40 clamps the connecting rod 20 to fasten external crown member 30 to internal crown members 10. Further, the internal crown members 10 can be connected to each other to bear a great force.

Please refer to FIG. 6, the spring clip 40 further comprises a first neck portion 413 disposed between the first fixed end 411 and the first movable end 412, and a second neck portion 423 disposed between the second fixed end 421 and the second movable end 422; a first distance D1 between the first neck portion 413 and the second neck portion 423 is less than a diameter of the protrusion block 11, so that the protrusion block 11 is located between the two spring arms 41.

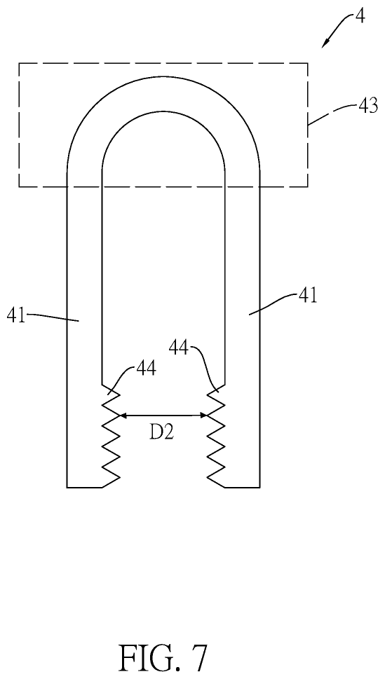

Please refer to FIG. 7, FIG. 7 is a schematic view showing configuration of the spring clip according to second embodiment present invention. As seen in FIG. 7, the artificial tooth (not shown in figure) further comprises an adhesive 43 used for adhering first fixed end 411 and the second fixed end 421 to fix the spring clip 40 on the external crown member (not shown in figure). Further, the spring clip 40 further comprises fixing components 44 mounted on the facing surfaces of the two spring arms 41 to clamp the protrusion block (not shown in figure), and the fixing components 44 are consecutive projections corresponding to each other.

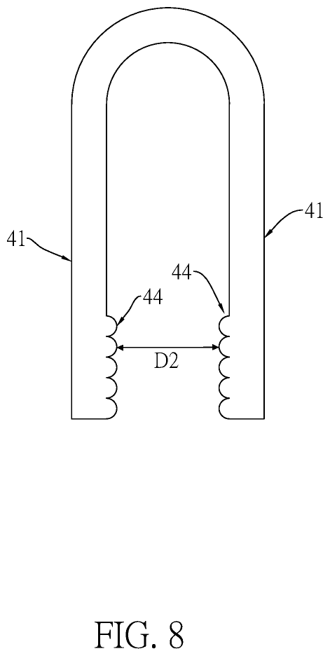

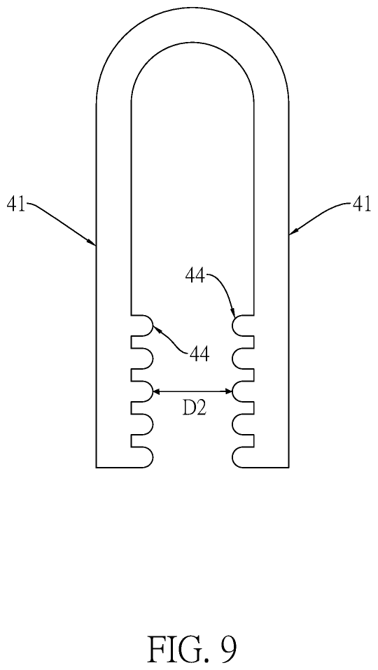

As seen in FIG. 7, the fixing components 44 are a plurality of zigzag units. Furthermore, please refer to FIGS. 8 and 9, FIG. 8 is a schematic view showing configuration of the spring clip according to third embodiment present invention; and FIG. 9 is a schematic view showing configuration of the spring clip according to fourth embodiment present invention. As seen in FIG. 8, the fixing components 44 are a plurality of circular arc units, such that the protruding block (not shown in figure) is fastened by the fixing components 44. As seen in FIG. 9, the fixing components 44 are a plurality of elliptical units, such that the protruding block (not shown in figure) is fastened by the fixing components 44.

As seen in FIG. 7 to FIG. 9, a second distance D2 formed between the fixing components 44 mounted on the facing surfaces of the two spring arms 41 is less than a diameter of the protrusion block (not shown in figure), when the external crown member (not shown in figure) is pressed down to fasten internal crown members (not shown in figure), the fixing components 44 are expanded by the protrusion block, so that the protrusion block is located between the two spring arms 41.

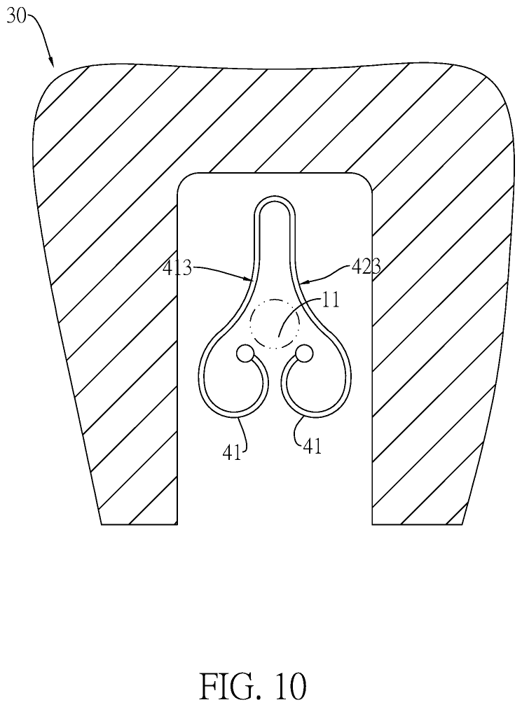

Please refer to FIG. 10, FIG. 10 is a schematic view showing spring clip clamping protrusion block according to fifth embodiment present invention. As seen in FIG. 10, the distance of the first neck portion 413 and the second neck portion 423 is less than a diameter of the protrusion block 11, so that the protrusion block 11 is located between the two spring arms 41.

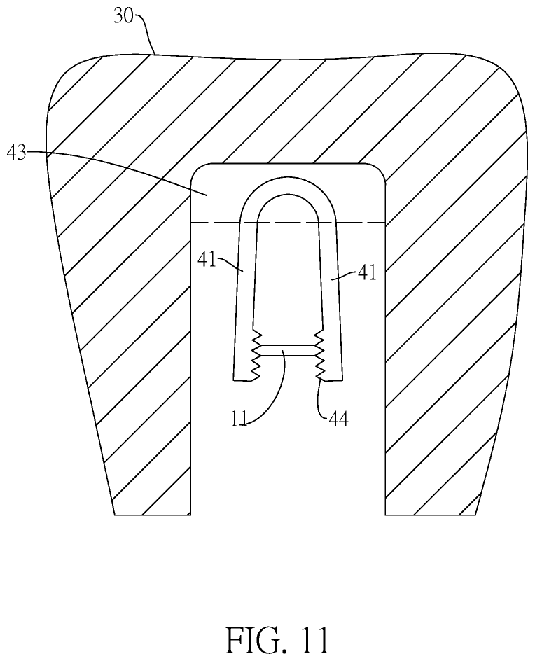

Please refer to FIG. 11, FIG. 11 is a schematic view showing spring clip clamping protrusion block according to sixth embodiment present invention. As seen in FIG. 11, the spring clips 41 clamp the protrusion block 11, and if a position of the protrusion block 11 is a distance from an opening, the dentist can easily remove or cut the excess part of the fixing components 44. The fixing components 44 are consecutive projections to achieve a multi-segment position, which is convenient for the dentist to fine adjustment.

The above descriptions for each figure explain the principles of the disclosure and its practical applications. The embodiments depicted above and the appended drawings are exemplary and are not intended to be exhaustive or to limit the scope of the disclosure. Modifications and variations are possible in view of the above teachings.

I claim:

1. An artificial tooth, comprising:
a plurality of internal crown members, which are respectively fitted to a plurality of abutments;
a plurality of connecting rods, each of which connects to at least two of the internal crown members;
at least one external crown member, which has at least one groove therein, the groove being formed to correspond to the internal crown members; and
at least one spring clip, which clamps a protrusion block formed on the internal crown members or on an adjacent tooth;
wherein the spring clip comprises two spring arms faced each other; the two spring arms have a first fixed end, a second fixed end, a first movable end and a second movable end; and the first fixed end opposites to the first movable end; the second fixed end opposites to the second movable end;
wherein the first fixed end connects to the second fixed end; the first movable end faces the second movable end; and the first fixed end and the second fixed end are fixed inside external crown member.

2. The artificial tooth mentioned in claim 1, wherein the spring clip clamps at least one connecting rod to fasten external crown member to internal crown members.

3. The artificial tooth mentioned in claim 1, further comprises an adhesive used for adhering first fixed end and the second fixed end to fix the spring clip on the external crown member

4. The artificial tooth mentioned in claim 1, further comprises a first neck portion disposed between the first fixed end and the first movable end, and a second neck portion disposed between the second fixed end and the second movable end; a first distance between the first neck portion and the second neck portion is less than a diameter of the protrusion block, so that the protrusion block is located between the two spring arms.

5. The artificial tooth mentioned in claim 1, further comprises fixing components mounted on the facing surfaces of the two spring arms to clamp the protrusion block, and the fixing components are consecutive projections corresponding to each other.

6. The artificial tooth mentioned in claim 5, wherein the fixing components are a plurality of zigzag units, a plurality of circular arc units or a plurality of elliptical units, such that the protrusion block is fastened by the fixing components.

7. The artificial tooth mentioned in claim 1, wherein a second distance formed between the fixing components mounted on the facing surfaces of the two spring arms is less than a diameter of the protrusion block, when the external crown member is pressed down to fasten internal crown members, the fixing components are expanded by the protrusion block, so that the protrusion block is located between the two spring arms.

8. The artificial tooth mentioned in claim 1, wherein the two spring arms are NiTi memory metal.
